(19) United States
(12) Patent Application Publication
(10) Pub. No.: US 2024/0120537 A1
(43) Pub. Date: Apr. 11, 2024

(54) COMPOSITION

(71) Applicant: Mexichem Fluor S.A. de C.V., San Luis Potosi (MX)

(72) Inventors: Andrew SHARRATT, Runcorn (GB); Miodrag OLJACA, Concord, MA (US); Ira SAXENA, Runcorn (GB)

(21) Appl. No.: 17/768,794

(22) PCT Filed: Oct. 20, 2020
(86) PCT No.: PCT/GB2020/052633

§ 371 Date: Apr. 13, 2022

Related U.S. Application Data
(60) Provisional application No. 62/923,700, filed on Oct. 21, 2019.

(30) Foreign Application Priority Data
Nov. 11, 2019 (GB) 1916352.6
Dec. 2, 2019 (GB) 1917565.2
May 22, 2020 (GB) 2007662.6

(51) Int. Cl. H01M 10/0567; H01M 10/0568; H01M 10/0569; H01M 10/42

(52) U.S. Cl. CPC H01M 10/0567; H01M 10/0568; H01M 10/0569; H01M 10/4235; H01M 10/4242; H01M 2300/0028

(57) ABSTRACT

Use of a compound of Formula I in a nonaqueous battery electrolyte formulation (I) wherein W is independently selected from the group consisting of H, F, Cl, Br and I; Y is independently selected from the group consisting of F, Cl, Br and I; Z is independently selected from the group consisting of H, O(CW₂)_{P}CW₃, (CW₂)_{P}CW₃, OCY₃, OCW₃, polyalkyiene glycol and polyoiesfer; n is an integer from 1-1000; one of T1 and T2 is W, the other is (CY₂)ₘCY₃; and p is an integer from 0 to 9,

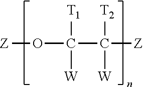

### COMPOSITION

The present disclosure relates to nonaqueous electrolytic solutions for energy storage devices including batteries and capacitors, especially for secondary batteries and devices known as super capacitors.

There are two main types of battery; primary and secondary. Primary batteries are also known as non-rechargeable batteries. Secondary batteries are also known as rechargeable batteries. A well-known type of rechargeable battery is the lithium-ion battery. Lithium-ion batteries have a high energy density, no memory effect and low self-discharge.

Lithium-ion batteries are commonly used for portable electronics and electric vehicles. In the batteries, lithium ions move from the negative electrode to the positive electrode during discharge and back when charging.

Typically, the electrolytic solutions include a non-aqueous solvent and an electrolyte salt, plus additives. The electrolyte is typically a mixture of organic carbonates such as ethylene carbonate, propylene carbonate, fluoroethylene carbonate and dialkyl carbonates containing a lithium ion electrolyte salt. Many lithium salts can be used as the electrolyte salt, common examples include lithium hexafluorophosphate (LiPF₆), lithium bis (fluorosulfonyl) imide “LiFSI” and lithium bis(trifluoromethanesulfonyl)imide (LiTFSI).

The electrolytic solution has to perform a number of separate roles within the battery.

The principal role of the electrolyte is to facilitate the flow of charge carriers between the cathode and anode. This occurs by transportation of metal ions within the battery from and or to one or both of the anode and cathode, where by chemical reduction or oxidation, electrical charge is liberated/adopted.

Thus, the electrolyte needs to provide a medium which is capable of solvating and/or supporting the metal ions.

Due to the use of lithium electrolyte salts and the interchange of lithium ions with lithium metal which is very reactive with water, as well as the sensitivity of other battery components to water, the electrolyte is usually non-aqueous.

Additionally, the electrolyte has to have suitable rheological properties to permit/enhance the flow of ions therein, at the typical operating temperature to which a battery is exposed and expected to perform.

Moreover, the electrolyte has to be as chemically inert as possible. This is particularly relevant in the context of the expected lifetime of the battery, with regard to internal corrosion within the battery (e.g. of the electrodes and casing) and the issue of battery leakage. Also of importance within the consideration of chemical stability is flammability. Unfortunately, typical electrolyte solvents can be a safety hazard, since they often comprise a flammable material.

This can be problematic as in operation when discharging or being discharged, batteries may accumulate heat. This is especially true for high density batteries such as lithium ion batteries. It is therefore desirable that the electrolyte displays a low flammability, with other related properties such as a high flash point.

It is also desirable that the electrolyte does not present an environmental issue with regard to disposability after use or other environmental issue such as global warming potential.

It is an object of the present invention to provide a nonaqueous electrolytic solution, which provides improved properties over the nonaqueous electrolytic solution of the prior art.

The listing or discussion of an apparently prior-published document in this specification should not necessarily be taken as an acknowledgement that the document is part of the state of the art or is common general knowledge.

### Use Aspects

According to a first aspect of the invention there is provided the use of a compound of Formula I in a nonaqueous battery electrolyte formulation.

According to a second aspect of the invention there is provided the use of a nonaqueous battery electrolyte formulation comprising a compound of Formula I in a battery.

### Composition/Device Aspects

According to a third aspect of the invention there is provided a battery electrolyte formulation comprising a compound of Formula I.

According to a fourth aspect of the invention there is provided a formulation comprising a metal ion and a compound of Formula I, optionally in combination with a solvent.

According to a fifth aspect of the invention there is provided a battery comprising a battery electrolyte formulation comprising a compound of Formula I.

### Method Aspects

According to a sixth aspect of the invention there is provided a method of reducing the flash point of a battery and/or a battery electrolyte formulation, comprising the addition of a formulation comprising a compound of Formula I.

According to a seventh aspect of the invention there is provided a method of powering an article comprising the use of a battery comprising a battery electrolyte formulation comprising a compound of Formula I.

According to an eighth aspect of the invention there is provided a method of retrofitting a battery electrolyte formulation comprising either (a) at least partial replacement of the battery electrolyte with a battery electrolyte formulation comprising a compound of Formula I, and/or (b) supplementation of the battery electrolyte with a battery electrolyte formulation comprising a compound of Formula I.

According to a ninth aspect of the invention there is provided a method of preparing a battery electrolyte formulation comprising mixing a compound of Formula I with a lithium containing salt and other solvents or co-solvents.

According to a tenth aspect of the invention there is provided a method of preparing a battery electrolyte formulation comprising mixing a composition comprising a compound of Formula I with a lithium-containing compound.

According to an eleventh aspect of the invention there is provided a method of improving battery capacity/charge transfer within a battery/battery life/etc. by the use of a compound of Formula I.

### Compound of Formula I

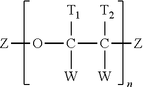 [0027] wherein
W is independently selected from the group consisting of H, F, Cl, Br and I;
Y is independently selected from the group consisting of F, Cl, Br and I;
Z is independently selected from the group consisting of H, O(CW₂)ₚCW₃, (CW₂)ₚCW₃ OCY₃, OCW₃, polyalkylene glycol and polyolester;
n is an integer from 1-1000;
one of T₁ and T₂ is W, the other is (CY₂)ₘCY₃;
and p is an integer from 0 to 9.

Within the general Formula I, in a preferred embodiment the compound can be one of Formula (Ia), (Ib) or (Ic), or a combination thereof:

### Compound of Formula (Ia)

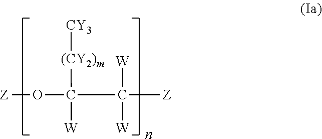

### Compound of Formula (Ib)

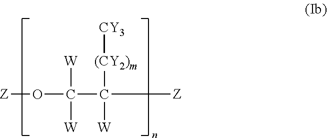

### Compound of Formula (Ic)

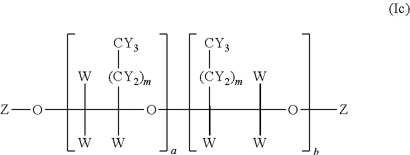

In each instance:
W is independently selected from the group consisting of H, F, Cl, Br and I;
Y is independently selected from the group consisting of F, Cl, Br and I;
Z is independently selected from the group consisting of H, O(CW₂)ₚCW₃, (CW₂)ₚCW₃,
OCY₃, OCW₃, polyalkylene glycol and polyolester;
n is an integer from 1-1000;
a & b are each an integer from 1 to 1000;
m is an integer from 0 to 3;
p is an integer from 0 to 9.

In the compound of Formula (Ic), the sub-units of the compound (which mimic the sub-units of Formula (Ia) and Formula (Ib)) can be present in any order in the compound.

In a preferred embodiment the compound of Formula (Ib) may alternatively be represented by the following:

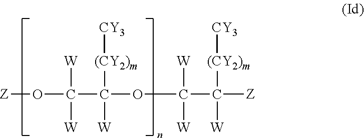

where n is an integer from 1-1000.

The compounds of Formulae (I), (la), (Ib), (Ic) and (Id) may have a M_{w} of ≤100000, preferably ≤50000, even more preferably 25000.

The compounds of Formulae (I), (la), (Ib), (Ic) and (Id) may have a polydispersity index of about 1.45, preferably about 1.35, more preferably about 1.30, even more preferably about 1.25.

In each instance of the compounds of Formulae (I), (la), (Ib), (Ic) and (Id):
Y is preferably F or Cl, more preferably Y is F.
W is preferably H, F or Cl. More preferably W is H.

Advantageously, m is an integer from 0 to 3, preferably 0.

n is preferably an integer from 2 to 1000, for example 5 to 500, preferably n is an integer from 6 to 100.

It will be understood that unless the context otherwise dictates, references to Formula (I) include references to Formula (Ia), Formula (Ib), Formula (Ic) and/or Formula (Id).

In some referred compounds of Formula (I) (which includes Formulae (la) to (Id)), at least one Z derivative may comprise a polyalkylene glycol. Alternatively, both Z derivatives may comprise a polyalkylene glycol (PAG). In both instances, the polyalkylene glycol may be selected from the group consisting of poly(ethylene) oxide, poly(propylene) oxide, and mixtures thereof. In such embodiments, the PAG groups may be conjugated to the compound of Formula (I) through the formation of an ether or ester bond between a hydroxyl end-capping group of Formula (I) (i.e. Z═OH) with an alcohol or carboxylic acid end-capped PAG.

In some compounds of Formula (I), at least one Z derivative may comprise a fluorinated-PAG (F-PAG). The F-PAG may be selected from the group consisting of F₃C-end capped PAGs and hydroxyl end capped PAGs.

The hydroxyl end groups of F-PAGs can provide further scope for derivatisation and can, for example, be converted to ether or ester groups. These groups can be aliphatic, aromatic, linear, branched, fluorine containing or functionalised in other ways to allow for further adjustments to the properties of the products.

In some compounds of Formula (I), the Z derivative may, independently, be an alkyl or alkoxy group containing from 1 to 10 carbon atoms.

Both Z derivatives may be the same. Alternatively, both Z derivatives may be different.

The compound of Formula (Ia) may conveniently be a compound of Formula (IIa):

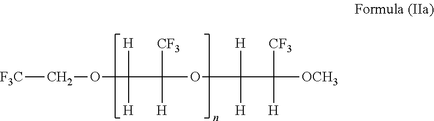

The skilled person will understand that the above formulas are representative only and that it will be appreciated that structural defects may exist in the polymer chains.

A composition may, for example, comprise at least two different compounds of Formula (I). In such instances, the value of n may be the same for the at least two compounds of Formula (I). Alternatively, the value of n may be different for the at least two compounds of Formula (I).

In some preferred embodiments, the compound of Formula (I) is a compound of Formula (Ib).

The compound of Formula (I) may be a mixture of compounds of Formula (Ia) and (Ib). In this situation, it is preferable that the majority of the mixture is a compound of Formula (Ib), for example greater than 50% by weight of the mixture is a compound of Formula (Ib), preferably greater than 75%, more preferably greater than 90% or 95%.

The compound of Formula (I) may be made by a method comprising the polymerisation of an epoxide precursor.

The epoxide precursor has the Formula (IV)

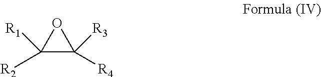

wherein:
R₁ is CF₃;
R₂ is H or F;
R₃ is H or F;
R₄ is H or CF₃.

Examples of the epoxide precursors that may be used include an epoxide according to Formula (IV), wherein R₁ is CF₃, R₂ is H, R₃ is H, R₄ is H (the epoxide of 3,3,3-trifluoropropene (1243zf); an epoxide according to Formula (IV), wherein, R₁ is CF₃, R₂ is F, R₃ is H and R₄ is H (the epoxide of 2,3,3,3-tetrafluropropene (1234yf); an epoxide according to Formula (IV), wherein R₁ is CF₃, R₂ is H, R₃ is F, R₄ is H (the epoxide of 1,3,3,3-tetrafluoropropene (1234ze)); and an epoxide according to Formula (IV), wherein R₁ is CF₃, R₂ is H, R₃ is CF₃, R₄ is H (the epoxide of 1,1,1,4,4,4-hexafluoro-2-butene (1336mzz)). Preferably the epoxide is the epoxide of 1243zf (1,1,1-trifluoro-2,3-epoxypropane).

The method may comprise the polymerisation of an epoxide using an initiator formed from a base and an alcohol, the alcohol chosen determining the nature of the group Z in Formula I.

Preferably, the base is a group I or group II metal hydroxide, more preferably a group I metal hydroxide, even more preferably sodium or potassium hydroxide, even more preferably potassium hydroxide.

Preferably, the alcohol is a primary alcohol. The primary alcohol may, for example, be a C₁ to C₁₀ glycol, preferably ethylene glycol. The primary alcohol may, for example, be a C₁ to C₁₀ branched or straight chain alcohol. The primary alcohol, for example, may be a fluorinated alcohol, for example a C₁ to C₁₀ fluorinated alcohol, preferably trifluoroethanol.

The polymerisation of the epoxide may be carried out in the absence of solvent.

The polymerisation reaction may be carried out at a temperature of from about 0 to about 130° C., preferably from about 40 to about 100° C., more preferably from about 50 to about 90° C.

The polymerisation reaction may be carried out at a pressure of from about 100 to about 1000.3 kPa, preferably about 101 kPa.

It is to be noted that the ninth aspect of the invention shall be taken to apply to all embodiments of Formula I.

### Advantages

In the aspects of the invention the electrolyte formulation has been found to be surprisingly advantageous.

The advantages of using compounds of Formula I in electrolyte solvent compositions manifest themselves in a number of ways. Their presence can reduce the flammability of the electrolyte composition (such as when for example measured by flashpoint). Their oxidative stability makes them useful for batteries required to work in harsh conditions, they are compatible with common electrode chemistries and can even enhance the performance of these electrodes through their interactions with them.

Additionally, electrolyte compositions comprising compounds of Formula I may have superior physical properties, including low viscosity and a low melting point, yet a high boiling point with the associated advantage of little or no gas generation in use. The electrolyte formulation may wet and spread extremely well over surfaces, particularly fluorine containing surfaces; this is postulated to result from a beneficial relationship between its adhesive and cohesive forces, to yield a low contact angle.

Furthermore, electrolyte compositions that comprise compounds of Formula I may have superior electro-chemical properties. These include improved capacity retention, improved cyclability and capacity, improved compatibility with other battery components, e.g. separators and current collectors and with all types of cathode and anode chemistries, including systems that operate across a range of voltages, especially high voltages, and which include additives such as silicon. In addition, the electrode formulations display good solvation of metal (e.g. lithium) salts and interaction with any other electrolyte solvents present.

Preferred features relating to the aspects of the invention follows below.

### Preferred Compounds

A preferred compound of the invention where n=1-50 is shown below:

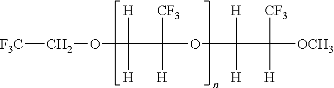

### Metal Salts

The nonaqueous electrolytic solution further comprises a metal electrolyte salt, present in an amount of 0.1 to 20 wt % relative to the total mass of the nonaqueous electrolyte formulation.

The metal salt generally comprises a salt of lithium, sodium, magnesium, calcium, lead, zinc or nickel.

Preferably the metal salt comprises a salt of lithium, such as those selected from the group comprising lithium hexafluorophosphate (LiPF₆), lithium perchlorate (LiClO₄), lithium tetrafluoroborate (LiBF₄), lithium triflate (LiSO₃CF₃), lithium bis(fluorosulfonyl)imide (Li(FSO₂)₂N) and lithium bis(trifluoromethanesulfonyl)imide (Li(CF₃SO₂)₂N).

Most preferably, the metal salt comprises LiPF₆. Thus, in a most preferred variant of the fourth aspect of the invention there is provided a formulation comprising LiPF₆ and a compound of Formula I, optionally in combination with a solvent.

### Other Solvents

The nonaqueous electrolytic solution may comprise an additional solvent. Preferred examples of solvents include fluoroethylene carbonate (FEC) and/or propylene carbonate (PC), dimethyl carbonate (DMC), ethylmethyl carbonate (EMC) or ethylene carbonate (EC).

Where present, the solvent makes up from 0.1 wt % to 99.9 wt % of the liquid component of the electrolyte.

### Additives

The nonaqueous electrolytic solution may include an additive.

Suitable additives may serve as surface film-forming agents, which form an ion-permeable film on the surface of the positive electrode or the negative electrode. This can pre-empt a decomposition reaction of the nonaqueous electrolytic solution and the electrolyte salt occurring on the surface of the electrodes, thereby preventing the decomposition reaction of the nonaqueous electrolytic solution on the surface of the electrodes.

Examples of film-forming agent additives include vinylene carbonate (VC), ethylene sulfite (ES), lithium bis(oxalato)borate (LiBOB), cyclohexylbenzene (CHB) and ortho-terphenyl (OTP). The additives may be used singly, or two or more may be used in combination.

When present the additive is present in an amount of 0.1 to 3 wt % relative to the total mass of the nonaqueous electrolyte formulation.

### Battery

The battery may comprise a primary (non-rechargeable) or a secondary (rechargeable) battery. Most preferably the battery comprises a secondary battery.

A battery comprising the nonaqueous electrolytic solutions will generally comprise several elements. Elements making up the preferred nonaqueous electrolyte secondary battery cell are described below. It is appreciated that other battery elements may be present (such as a temperature sensor); the list of battery components below is not intended to be exhaustive.

### Electrodes

The battery generally comprises a positive and negative electrode. Usually the electrodes are porous and permit metal ions (lithium ions) to move in and out of their structures by a process called insertion (intercalation) or extraction (deintercalation).

For rechargeable batteries (secondary batteries), the term cathode designates the electrode where reduction is taking place during the discharge cycle. For lithium-ion cells the positive electrode (“cathode”) is the lithium-based one.

### Positive Electrode (Cathode)

The positive electrode is generally composed of a positive electrode current collector such as a metal foil, optionally with a positive electrode active material layer disposed on the positive electrode current collector.

The positive electrode current collector may be a foil of a metal that is stable at a range of potentials applied to the positive electrode, or a film having a skin layer of a metal that is stable at a range of potentials applied to the positive electrode. Aluminium (A1) is desirable as the metal that is stable at a range of potentials applied to the positive electrode.

The positive electrode active material layer generally includes a positive electrode active material and other components such as a conductive agent and a binder. This is generally obtained by mixing the components in a solvent, applying the mixture onto the positive electrode current collector, followed by drying and rolling.

The positive electrode active material may be a lithium (Li) or a lithium-containing transition metal oxide. The transition metal element may be at least one selected from the group consisting of scandium (Sc), manganese (Mn), iron (Fe), cobalt (Co), nickel (Ni), copper (Cu) and yttrium (Y). Of these transition metal elements, manganese, cobalt and nickel are the most preferred.

Further, in certain embodiments transition metal fluorides may be preferred.

Some of the transition metal atoms in the transition metal oxide may be replaced by atoms of a non-transition metal element. The non-transition element may be selected from the group consisting of magnesium (Mg), aluminium (Al), lead (Pb), antimony (Sb) and boron (B). Of these non-transition metal elements, magnesium and aluminium are the most preferred.

Preferred examples of positive electrode active materials include lithium-containing transition metal oxides such as LiCoO₂, LiNiO₂, LiMn₂O₄, LiMnO₂, LiNi_{1-y}Co_{y}O₂ (0<y<1), LiNi_{1-y}Co_{y}MnO₂ (0<y+z<1) and LiNi_{1-y-z}Co_{y}Al_{z}O₂ (0<y+z<1). LiNi_{1-y-z}Co_{y}Mn_{z}O₂ (0<y+z<0.5) and LiNi_{1-y-z}Co_{y}Al_{z}O₂ (0<y+z<0.5) containing nickel in a proportion of not less than 50 mol % relative to all the transition metals are desirable from the perspective of cost and specific capacity. These positive electrode active materials contain a large amount of alkali components and thus accelerate the decomposition of nonaqueous electrolytic solutions to cause a decrease in durability. However, the nonaqueous electrolytic solution of the present disclosure is resistant to decomposition even when used in combination with these positive electrode active materials.

The positive electrode active material may be a lithium (Li) containing transition metal fluoride. The transition metal element may be at least one selected from the group consisting of scandium (Sc), manganese (Mn), iron (Fe), cobalt (Co), nickel (Ni), copper (Cu) and yttrium (Y). Of these transition metal elements, manganese, cobalt and nickel are the most preferred.

A conductive agent may be used to increase the electron conductivity of the positive electrode active material layer. Preferred examples of the conductive agents include conductive carbon materials, metal powders and organic materials. Specific examples include carbon materials such as acetylene black, ketjen black and graphite, metal powders such as aluminium powder, and organic materials such as phenylene derivatives.

A binder may be used to ensure good contact between the positive electrode active material and the conductive agent, to increase the adhesion of the components such as the positive electrode active material with respect to the surface of the positive electrode current collector. Preferred examples of the binders include fluoropolymers and rubber polymers, such as polytetrafluoroethylene (PTFE), polyvinylidene fluoride (PVdF) ethylene-propylene-isoprene copolymer and ethylene-propylene-butadiene copolymer. The binder may be used in combination with a thickener such as carboxymethylcellulose (CMC) or polyethylene oxide (PEO).

### Negative Electrode (Anode)

The negative electrode is generally composed of a negative electrode current collector such as a metal foil, optionally with a negative electrode active material layer disposed on the negative electrode current collector.

The negative electrode current collector may be a foil of a metal. Copper (lithium free) is suitable as the metal. Copper is easily processed at low cost and has good electron conductivity.

Generally, the negative electrode comprises carbon, such as graphite or graphene.

Silicon based materials can also be used for the negative electrode. A preferred form of silicon is in the form of nano-wires, which are preferably present on a support material. The support material may comprise a metal (such as steel) or a non-metal such as carbon.

The negative electrode may include an active material layer. Where present the active material layer includes a negative electrode active material and other components such as a binder. This is generally obtained by mixing the components in a solvent, applying the mixture onto the positive electrode current collector, followed by drying and rolling.

Negative electrode active materials are not particularly limited, provided the materials can store and release lithium ions. Examples of suitable negative electrode active materials include carbon materials, metals, alloys, metal oxides, metal nitrides, and lithium-intercalated carbon and silicon. Examples of carbon materials include natural/artificial graphite, and pitch-based carbon fibres. Preferred examples of metals include lithium (Li), silicon (Si), tin (Sn), germanium (Ge), indium (In), gallium (Ga), titanium (Ti), lithium alloys, silicon alloys and tin alloys. An example of a lithium-based material includes lithium titanate (Li₂Ti0₃)

As with the positive electrode, the binder may be a fluoropolymer or a rubber polymer and is desirably a rubbery polymer, such as styrene-butadiene copolymer (SBR). The binder may be used in combination with a thickener.

### Separator

A separator is preferably present between the positive electrode and the negative electrode. The separator has insulating properties. The separator may comprise a porous film having ion permeability. Examples of porous films include microporous thin films, woven fabrics and nonwoven fabrics. Suitable materials for the separators are polyolefins, such as polyethylene and polypropylene.

### Case

The battery components are preferably disposed within a protective case.

The case may comprise any suitable material which is resilient to provide support to the battery and an electrical contact to the device being powered.

In one embodiment the case comprises a metal material, preferably in sheet form, moulded into a battery shape. The metal material preferably comprises a number of portions adaptable be fitted together (e.g. by push-fitting) in the assembly of the battery. Preferably the case comprises an iron/steel-based material.

In another embodiment the case comprises a plastics material, moulded into a battery shape. The plastics material preferably comprises a number of portions adaptable be joined together (e.g. by push-fitting/adhesion) in the assembly of the battery. Preferably the case comprises a polymer such as polystyrene, polyethylene, polyvinyl chloride, polyvinylidene chloride, or polymonochlorofluoroethylene. The case may also comprise other additives for the plastics material, such as fillers or plasticisers. In this embodiment wherein the case for the battery predominantly comprises a plastics material a portion of the casing may additionally comprise a conductive/metallic material to establish electrical contact with the device being powered by the battery.

### Arrangement

The positive electrode and negative electrode may be wound or stacked together through a separator. Together with the nonaqueous electrolytic solution they are accommodated in the exterior case. The positive and negative electrodes are electrically connected to the exterior case in separate portions thereof.

### Module/Pack

A number/plurality of battery cells may be made up into a battery module. In a battery module the battery cells may be organised in series and/or in parallel. Typically, these are encased in a mechanical structure.

A battery pack may be assembled by connecting multiple modules together in series or parallel. Typically, battery packs include further features such as sensors and controllers, including battery management systems and thermal management systems. The battery pack generally includes an encasing housing structure to make up the final battery pack product.

### End Uses

The battery of the invention, in the form of an individual battery/cell, module and/or pack (and the electrolyte formulations therefor) are intended to be used in one or more of a variety of end products.

Preferred examples of end products include portable electronic devices, such as GPS navigation devices, cameras, laptops, tablets and mobile phones. Other preferred examples of end products include vehicular devices (as provision of power for the propulsion system and/or for any other electrical system or devices present therein) such as electrical bikes and motorbikes as well as automotive applications (including hybrid and purely electric vehicles).

Preferences and options for a given aspect, feature or parameter of the invention should, unless the context indicates otherwise, be regarded as having been disclosed in combination with any and all preferences and options for all other aspects, features and parameters of the invention.

The invention will now be illustrated with reference to the following non-limiting examples.

### EXAMPLES

The invention is illustrated by the following non-limiting examples.

Compounds according to the invention were synthesised by the following method.

### General Method

An initiator mixture was prepared by adding, with stirring and cooling, a quantity of base (e.g. 85-86% KOH) to an alcohol (e.g. ethylene glycol or trifluoroethanol) in a Pyrex round-bottomed flask along with 2-3 drops of Aliquat 336 (Stark's catalyst). When the base had dissolved in the alcohol the reaction flask was equipped with a dropping funnel and a condenser before the epoxide monomer (e.g. 3,3,3-trifluoro-1,2-epoxypropane) was added. The mixture was then heated with stirring. At the end of the reaction the product was cooled and dissolved in a minimum quantity of chloroform (e.g. 250 ml). This chloroform solution was washed with acidified water (e.g. 4 g 36% HCl in 100 ml water) and then three times with water alone (e.g. 100 ml). The washed chloroform solution of the polymer product was dried over anhydrous sodium sulphate and after filtration the solvent was removed by distillation at reduced pressure.

The polymer products obtained were analysed and characterised by gel permeation chromatography (GPC).

GPC was performed on a Shimadzu Prominence LC system equipped with an RI detector with a 300 mm×75 mm, 5 μm PLgel 100 Å and 300 mm×7.5 mm, 5 μm PLgel 500 Å column in series at 40° C. with a THF eluent at 1.0 ml/min. The method was calibrated with poly(styrene) standards with MW between 1000 and 10000.

Viscometry: Viscometry was performed on a TA Instruments Discovery Hybrid Rheometer using a 40 mm 2.008° cone plate geometry at 10 rad/s between −20 and 70° C.

Using this general method, a series of polymer products were produced. Details for each preparation and key properties of each product are outlined in the Table 1.

TABLE 1
Preparative examples

| | Recipe | | | | Batch | GPC Analysis | | | | | | | |
|---|---|---|---|---|---|---|---|---|---|---|---|---|---|
| | | TFPO | Temp | Yield | time | | | M [symbol] /M [symbol] | Viscometry, η [symbol] at ° C. | | | | |
| Example | Initiator (g) | (g) | (° C.) | [symbol] | [symbol] hrs [symbol] | M [symbol] | M [symbol] | (PDI) | [symbol] 10 | 0 | 20 | 40 | 60 |
| 1-F(D) | TFEA 1.1 | [symbol] | 70 | [symbol] | 48 | 1516 | 1712 | 1.13 | [symbol] | [symbol] | [symbol] | [symbol] | 44.5 |
| | K [symbol] H 1.1 | | | | | | | | | | | | |
| 2-F(F) | TFEA 10 | 135 | 70 | [symbol] . | 48 | 1478 | 1401 | 1.05 | [symbol] | [symbol] | 130.2 | 40.1 | 18.1 |
| | K [symbol] H 2.0 | | | | | | | | | | | | |

[symbol]

indicates data missing or illegible when filed

The preparative procedure used in Example 2 was scaled up to yield 1440 g of the F(F) product, which was dissolved in tetrahydrofuran (THF, 1000 ml) and cooled to 5° C. Potassium t-butoxide (220 g) was added to the THF solution in portions such that the temperature never exceeded 10° C.

The resulting solution was stirred for 30 minutes before methyl iodide (142 g) was added. The reaction mixture was allowed to warm to room temperature and stirred overnight. The reaction mixture was then quenched with water (2000 ml) and after phase separation the organic layer was washed an additional 5 times with water (1000 ml). The organic layer was dried over anhydrous MgSO₄ prior to removal of the THF solvent and other volatiles by vacuum distillation at 90° C. and 1 mmHg for 1-2 hours. The final product was treated with active carbon and filtered to remove haze which yield 1100 g of a product of Formula I:

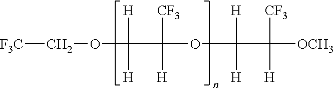

| | | | | | | Flash |
|---|---|---|---|---|---|---|
| Mn | | | | Viscosity | Boiling | point |
| \| | Mw | PDI | Average n | (cP@40° C.) | point (° C.) | (° C.) |
| 1645 | 1737 | 1.06 | 14 | 19.26 | 360-380 | >200 |

### Compositions

Compositions comprising the product of Formula I (as in the Preparative Example above) were prepared as shown in the Table 2 below.

TABLE 2
Composition examples

| | % Compound of | |
|---|---|---|
| Composition | Formula I | % Other Component |
| A1 | 10% | 90% - 1 Molar LiFSI in |
| | | Propylene carbonate & |
| | | Fluoroethylene carbonate (9:1 Ratio) |
| A2 | 10% | 90% - 1 Molar LiFSI in |
| | | Propylene carbonate |
| A3 | 10% | 90% - 1 Molar LiFSI in |
| | | Ethylene carbonate & |
| | | Ethyl methyl carbonate (3:7 Ratio) |
| B1 | 10% | 90% - 1 Molar LiPF₆ in |
| | | Ethylene carbonate & |
| | | Ethyl methyl carbonate (3:7 Ratio) |
| B2 | 10% | 90% - 1 Molar LiPF₆ in |
| | | Propylene carbonate & |
| | | Fluoroethylene carbonate (9:1 Ratio) |

All % by weight.
(LiFSi = Lithium bis(fluorsulphonyl)imde)

### Flammability and Safety Testing

### Flash Point

Flashpoints were determined using a Miniflash FLP/H device from Grabner Instruments following the ASTM D6450 standard method:

| | Concentration (% wt) in standard electrolyte 1M LiPF₆ in (30% Ethylene | | | | | |
|---|---|---|---|---|---|---|
| | carbonate & 70% ethyl methyl carbonate) | | | | | |
| | 0 | 2 | 5 | 10 | 30 | 100 |
| Component | Flashpoint (° C.) | | | | | |
| F-PAG F(F) Methyl end | 32 ± 2 | 33 ± 1 | 35 ± 1 | 36 ± 1 | 42 ± 1 | 218 ± 8 |
| capped | | | | | | |

These measurements demonstrate that the addition of the additive designated F-PAGF(F) Methyl end capped raised the flashpoint of the standard electrolyte solution.

### Self-Extinguishing Time

Self-extinguishing time was measured with a custom-built device that contained an automatically controlled stopwatch connected to an ultraviolet light detector:
The electrolyte to be examined (500 μL) was applied to a Whatman GF/D (Ø=24 mm) glass microfiber filter
The ignition source was transferred under the sample and held in this its position for a preset time (1, 5 or 10 seconds) to ignite the sample. Ignition and burning of the sample were detected using a UV light detector.
Evaluation is carried out by plotting the burning time/weight of electrolyte [s g⁻¹] over ignition time [s] and extrapolation by linear regression line to ignition time=0 s
Self-extinguishing time (s·g⁻¹) is the time that is needed until the sample stops burning once inflamed.

| | Concentration (% wt) in standard electrolyte 1M LiPF₆ in (30% Ethylene | | | | | |
|---|---|---|---|---|---|---|
| | carbonate & 70% ethyl methyl carbonate) | | | | | |
| | 0 | 2 | 5 | 10 | 30 | 100 |
| Component | Self-extinguishing time (s · g⁻¹) | | | | | |
| F-PAGF(F) Methyl end | 39 ± 2 | 40 ± 3 | 32 ± 2 | 29 ± 2 | 38 ± | 32 ± 5* |
| capped | | | | | | |

*The neat compound needed more than 2 seconds exposure to the flame to ignite

These measurements demonstrate that the compound F-PAGF(F) Methyl end capped has flame retarding properties.

### Electrochemical Testing

### Drying

Before testing F-PAGF(F) Methyl end capped was dried by treatment with a pre-activated type 4A molecular sieve. Water levels in the pre- and post-treated samples were determined by the Karl Fischer method:

| | Water level | Water level |
|---|---|---|
| | pre-treatment | post-treatment |
| Compound | (ppm w/v) | (ppm w/v) |
| F-PAGF(F) Methyl end capped | 373 | <10 |

### Electrolyte Formulation

Electrolyte preparation and storage was carried out in an argon filled glove box (H₂O and O₂<0.1 ppm). The base electrolyte was 1M LiPF₆ in ethylene carbonate:ethyl methyl carbonate (3:7 wt. %) with F-PAGF(F) Methyl end capped additive at concentrations of 2, 5, 10 and 30 wt. %.

### Cell Chemistry and Construction

The performance of each electrolyte formulation was tested in multi-layer pouch cells over 50 cycles (2 cells per electrolyte):

Chemistry 1: Lithium-Nickel-Cobalt-Manganese-Oxide (NCM622) positive electrode and artificial graphite (specific capacity: 350 mAh g⁻¹) negative electrode. The area capacity of NMC622 and graphite amounted to 3.5 mAh cm⁻² and 4.0 mAh cm⁻², respectively. The N/P ratio amounted to 115%.

Chemistry 2: Lithium-Nickel-Cobalt-Manganese-Oxide (NCM622) positive electrode and SiOₓ/graphite (specific capacity: 550 mAh g⁻¹) negative electrode. The area capacity of NMC622 and SiOₓ/graphite amount to 3.5 mAh/cm⁻² and 4.0 mAh cm⁻², respectively. The N/P ratio amounted to 115%

The test pouch cells had the following characteristics:
Nominal capacity 240 mAh+/−2%
Standard deviations:

Capacity: ±0.6 mAh

Coulombic Efficiency (CE) 1^{st} cycle: ±0.13%

Coulombic Efficiency (CE) subsequent cycles: ±0.1%

Positive electrode: NMC-622
Active material content: 96.4%
Mass loading: 16.7 mg cm⁻²

Negative electrode: Artificial Graphite
Active material content: 94.8%
Mass loading: 10 mg cm⁻²
Separator: PE(16 μm)+4 μm Al₂O₃
Balanced at cut-off voltage of 4.2 V

Negative electrode: Artificial graphite+SiO
Active material content: 94.6%
Mass loading: 6.28 mg cm⁻²
Separator: PE(16 μm)+4 μm Al₂O₃
Balanced at cut-off voltage of 4.2 V

After assembly the following formation protocol was used:
1. Step charge to 1.5 V followed by 5 h rest step (wetting step @ 40° C.)
2. CCCV (C/10, 3.7 V (Iₗᵢₘᵢₜ: 1 h)) (preformation step)
3. Rest step (6 h)
4. CCCV (C/10, 4.2 V (Iₗᵢₘᵢₜ: 0.05C)) rest step (20 min)
5. CC discharge (C/10, 3.8 V), (degassing of the cell)
6. CC discharge (C/10, 2.8 V)

Following this formation step, the cells were tested as follows:
Rest step (1.5 V, 5 h), CCCV (C/10, 3.7 V (1 h))
Rest step (6 h), CCCV (C/10, 4.2 V (Iₗᵢₘᵢₜ: 0.05C))
Rest step (20 min), CC discharge (C/10, 3.8 V)
Degassing step
Discharge (C/10, 2.8 V), rest step (5 h)
CCCV (C/3, 4.2 V (Limit: 0.05C)), rest step (20 min)
CC discharge (C/3, 2.8 V)
50 cycles or until 50% SOH is reached at 40° C.:

CCCV (C/3, 4.2 V (Limit: 0.02C)), rest step (20 min)

CC discharge (C/3, 3.0 V), rest step (20 min)

### Test Results

The test results for the additive F-PAGF(F) Methyl end capped in each cell chemistry are summarised in Tables 3 and 4 and FIGS. 3 and 4. From this data it can be seen that the additive in both cell chemistries had a positive influence on cell performance. These results combined with the safety related studies demonstrate that the compounds of this invention simultaneously improved both the safety and performance of energy storage devices containing them.

TABLE 3
Electrochemical performance of F-PAGF(F) Methyl end capped - Cell Chemistry 1

| | | | Base electrolyte + | | Base electrolyte + | | Base electrolyte + | | Base electrolyte + | |
|---|---|---|---|---|---|---|---|---|---|---|
| | Base electrolyte | | 2 wt. % MEXI-1 | | 5 wt. % MEXI-1 | | 10 wt. % MEXI-1 | | 30 wt. % MEXI-1 | |
| | Discharge | Coulombic | Discharge | Coulombic | Discharge | Coulombic | Discharge | Coulombic | Discharge | Coulombic |
| | capacity | efficiency | capacity | efficiency | capacity | efficiency | capacity | efficiency | capacity | efficiency |
| Cycle No. | (mAh) | (%) | (mAh) | (%) | (mAh) | (%) | (mAh) | (%) | (mAh) | (%) |
| 1^{st} (0.1 C) | 232.2 | 90.6 | 240.1 | 90.5 | 238.7 | 90.5 | 239.0 | 90.8 | 239.1 | 90.4 |
| 3^{rd} (0.3 C) | 224.4 | 99.6 | 232.8 | 99.5 | 231.0 | 99.5 | 231.5 | 99.5 | 225.2 | 98.2 |
| 50^{th} (0.3 C) | 218.1 | 99.8 | 227.0 | 99.8 | 225.0 | 99.8 | 223.9 | 99.8 | 163.4 | 99.3 |

TABLE 4
Electrochemical performance of F-PAGF(F) Methyl end capped - Cell Chemistry 2

| | | | Base electrolyte + | | Base electrolyte + | | Base electrolyte + | | Base electrolyte + | |
|---|---|---|---|---|---|---|---|---|---|---|
| | Base electrolyte | | 2 wt. % MEXI-1 | | 5 wt. % MEXI-1 | | 10 wt. % MEXI-1 | | 30 wt. % MEXI-1 | |
| | Discharge | Coulombic | Discharge | Coulombic | Discharge | Coulombic | Discharge | Coulombic | Discharge | Coulombic |
| | capacity | efficiency | capacity | efficiency | capacity | efficiency | capacity | efficiency | capacity | efficiency |
| Cycle No. | (mAh) | (%) | (mAh) | (%) | (mAh) | (%) | (mAh) | (%) | (mAh) | (%) |
| 1^{st} (0.1 C) | 199.6 | 74.5 | 201.4 | 74.8 | 201.6 | 74.9 | 201.5 | 75.0 | 200.5 | 74.9 |
| 3^{rd} (0.3 C) | 176.3 | 97.0 | 177.7 | 97.0 | 178.5 | 97.1 | 178.3 | 97.1 | 176.3 | 96.8 |
| 50^{th} (0.3 C) | 125.7 | 99.6 | 126.3 | 99.6 | 127.9 | 99.6 | 129.0 | 99.7 | 127.1 | 99.7 |

### FIGURES

FIG. 1 shows a ¹⁹F NMR spectrum of compositions A1, A2 and A3.

FIG. 2 shows a ¹⁹F NMR spectrum of compositions B1 and B2.

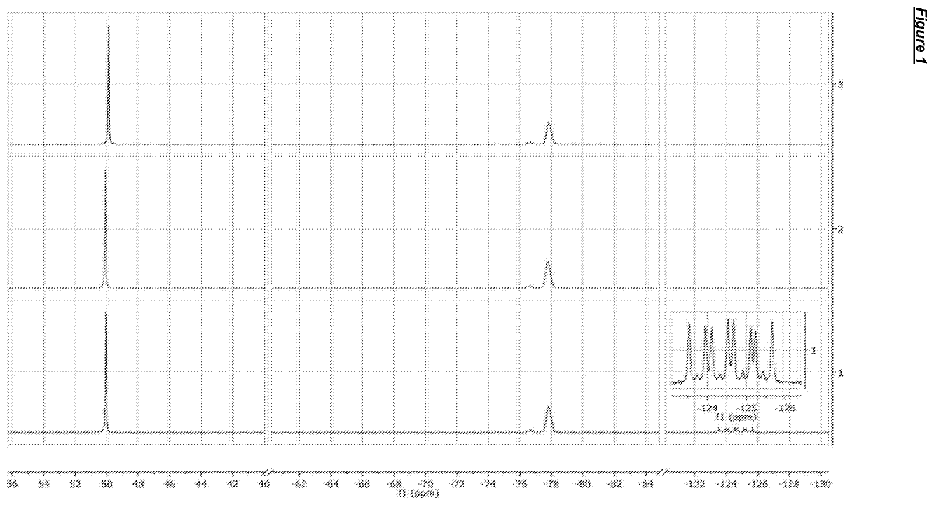

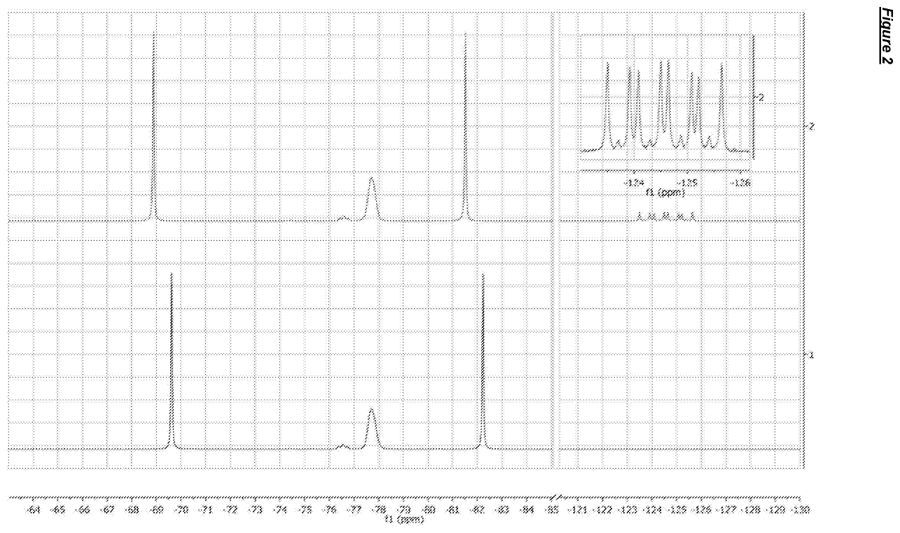

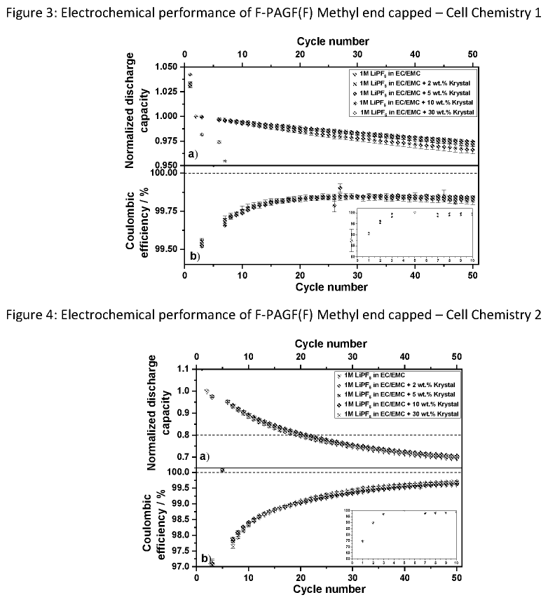

1. A nonaqueous battery electrolyte formulation, comprising a compound of Formula (I): 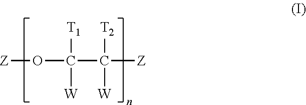
wherein each W is independently selected from the group consisting of H, F, Cl, Br, and I;
each Y is independently selected from the group consisting of F, Cl, Br, and I;
each Z is independently selected from the group consisting of H, O(CW₂)ₚCW₃, (CW₂)ₚCW₃, OCY₃, OCW₃, polyalkylene glycol, and polyolester;
n is an integer from 1 to 1000;
one of T₁ and T₂ is W, and the other of T₁ and T₂ is (CY₂)ₘCY₃; and
p is an integer from 0 to 9.

2. The formulation according to claim 1, wherein the compound of Formula (I) is a compound of Formula (Ia), (Ib), or (Ic): 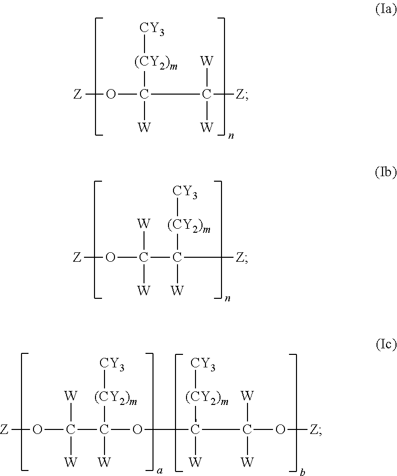
wherein m is an integer from 0 to 3;
and
a and b are each independently an integer from 1 to 1000.

3. A battery, comprising the formulation according to claim 1.

4. The formulation according to claim 1, further comprising a metal electrolyte salt, present in an amount of from 0.1 to 20 wt % relative to a total mass of the formulation, wherein the metal salt is a salt of lithium, sodium, magnesium, calcium, lead, zinc, or nickel.

5. (canceled)

6. The formulation according to claim 4, wherein the metal salt is a salt of lithium selected from the group consisting of lithium hexafluorophosphate (LiPF₆), lithium hexafluoroarsenate monohydrate (LiAsF₆·H₂O), lithium perchlorate (LiClO₄), lithium tetrafluoroborate (LiBF₄), lithium triflate (LiSO₂CF₃), lithium bis(fluorosulfonyl)imide (Li(FSO₂)₂N), and lithium bis(trifluoromethanesulfonyl)imide (Li(CF₃SO₂)₂N).

7. The formulation according to claim 1, further comprising an additional solvent in an amount of from 0.1 wt % to 99.9 wt % of a liquid component of the formulation, wherein the additional solvent is selected from the group consisting of fluoroethylene carbonate (FEC), propylene carbonate (PC), and ethylene carbonate (EC).

8-16. (canceled)

17. A method of reducing the flammability of a battery and/or a battery electrolyte, the method comprising adding to the battery and/or the battery electrolyte the formulation according to claim 1.

18. A method of powering an article comprising of a battery, the method comprising a adding to the battery a compound of Formula (I): 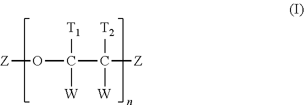
wherein each W is independently selected from the group consisting of H, F, Cl, Br, and I;
each Y is independently selected from the group consisting of F, Cl, Br, and I;
each Z is independently selected from the group consisting of H, O(CW₂)ₚCW₃, (CW₂)ₚCW₃, OCY₃, OCW₃, polyalkylene glycol, and polyolester;
n is an integer from 1 to 1000;
one of T₁ and T₂ is W, and the other of T₁ and T₂ is (CY₂)ₘCY₃; and
p is an integer from 0 to 9.

19. A method of retrofitting a battery electrolyte, the method comprising (a) at least partially replacing the battery electrolyte with the formulation according to claim 1; and/or (b) supplementing the battery electrolyte with the formulation.

20. A method of preparing the compound of Formula (I) according to claim 1, the method comprising polymerizing an epoxide precursor of Formula (IV): 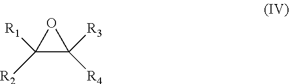
wherein
R₁ is CF₃;
R₂ is H or F;
R₃ is H or F; and
R₄ is H or CF₃; so as to produce the compound of Formula (I).

21. A method of preparing the formulation according to claim 1, the method comprising mixing an electrolyte with the compound of Formula (I) so as to produce the formulation.

22. A The method according to claim 18, wherein a capacity of the battery and/or a charge transfer within the battery is improved relative to a battery without the formulation.

23. The method according to claim 18, wherein the formulation comprises a metal electrolyte salt, present in an amount of from 0.1 to 20 wt % relative to a total mass of the nonaqueous electrolyte formulation, wherein the metal salt is a salt of lithium, sodium, magnesium, calcium, lead, zinc, or nickel.

24. (canceled)

25. A The method according to claim 23, wherein the metal salt is a salt of lithium selected from the group consisting of lithium hexafluorophosphate (LiPF₆), lithium hexafluoroarsenate monohydrate (LiAsF₆·H₂O), lithium perchlorate (LiClO₄), lithium tetrafluoroborate (LiBF₄), lithium triflate (LiSO₂CF₃), lithium bis(fluorosulfonyl)imide (Li(FSO₂)₂N), and lithium bis(trifluoromethanesulfonyl)imide (Li(CF₃SO₂)₂N).

26. The method according to claim 18, wherein the formulation comprises an additional solvent in an amount of from 0.1 wt % to 99.9 wt % of a liquid component of the formulation, wherein the additional solvent is selected from the group consisting of fluoroethylene carbonate (FEC), propylene carbonate (PC), and ethylene carbonate (EC).

27. (canceled)

28. A nonaqueous battery electrolyte formulation, comprising a compound of Formula (Ia), (Ib), (Ic), or (Id): 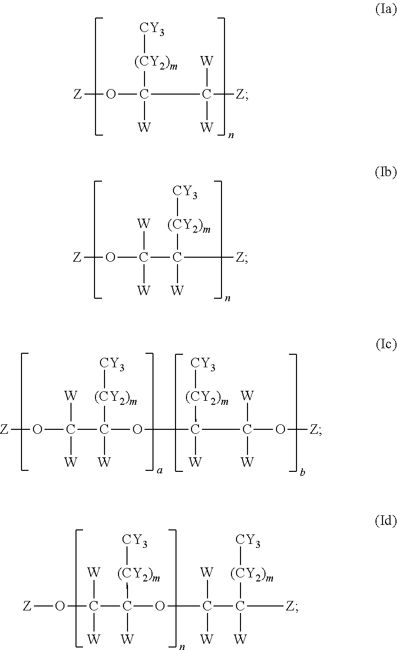
wherein each W is independently selected from the group consisting of H, F, Cl, Br, and I;
each Y is independently selected from the group consisting of F, Cl, Br, and I;
each Z is independently selected from the group consisting of H, O(CW₂)ₚCW₃, (CW₂)ₚCW₃, OCY₃, OCW₃, polyalkylene glycol, and polyolester;
n is an integer from 1 to 1000;
one of T₁ and T₂ is W, and the other of T₁ and T₂ is (CY₂)ₘCY₃;
m is an integer from 0 to 3;
p is an integer from 0 to 9; and
a and b are each independently an integer from 1 to 1000.

29. A battery, comprising the formulation according to claim 28.

30. The formulation according to claim 28, further comprising a metal electrolyte salt, present in an amount of from 0.1 to 20 wt % relative to a total mass of the formulation, wherein the metal salt is a salt of lithium, sodium, magnesium, calcium, lead, zinc, or nickel.

31. The formulation according to claim 30, wherein the metal salt is a salt of lithium selected from the group consisting of lithium hexafluorophosphate (LiPF₆), lithium hexafluoroarsenate monohydrate (LiAsF₆·H₂O), lithium perchlorate (LiClO₄), lithium tetrafluoroborate (LiBF₄), lithium triflate (LiSO₂CF₃), lithium bis(fluorosulfonyl)imide (Li(FSO₂)₂N), and lithium bis(trifluoromethanesulfonyl)imide (Li(CF₃SO₂)₂N).

32. The formulation according to claim 28, further comprising an additional solvent in an amount of from 0.1 wt % to 99.9 wt % of a liquid component of the formulation, wherein the additional solvent is selected from the group consisting of fluoroethylene carbonate (FEC), propylene carbonate (PC), and ethylene carbonate (EC).
